(19) United States
(12) Patent Application Publication
(10) Pub. No.: US 2006/0090775 A1
(43) Pub. Date: May 4, 2006

(54) Machine dish-washing process

(75) Inventor: Ewit De Kuyper, Cruquius (NL)

Correspondence Address: YOUNG & THOMPSON, 745 SOUTH 23RD STREET, 2ND FLOOR, ARLINGTON, VA, 22202, US

(73) Assignee: EPENHUYSEN CHEMIE N.V., ZWIJNDRECHT (NL)

(21) Appl. No.: 10/976,849

(22) Filed: Nov. 1, 2004

(51) Int. Cl. B08B 9/20; B08B 3/00

(52) U.S. Cl. 134/25.2; 134/34

(57) ABSTRACT

Machine dish washing process is invented wherein a detergent is supplied from a storage supply and is dispersed from at least one nozzle over crockery within the dish washing machine such that said crockery is washed with said detergent and said detergent is removed from said crockery thereafter, wherein said detergent is dispersed in a pulsating manner, e.g. said detergent leaves the nozzle as a pulsating flow. Preferably said pulse frequency is below 15 Hz, and during a single pulsating cycle, the dispensing rate changes e.g. from zero to maximum and back to zero.

The invention relates to a machine dish-washing process and more particular to an improvement in continuous or discontinuous machine dish-washing, e.g. conducted using a single tank or multi tank or conveyor type dish washer. The invention is also concerned with a dish washing machine that is adapted to carry out said process.

The invention is also in the field of dispensing a fluid, such as particles or a liquid, preferably foaming. Preferably the fluid contains one or more preferably chemically active substances. A particular example is a detergent. Other liquids with a preferably chemically active substance are e.g. insecticide, paint, coating, adhesive, cleaner, nutrient. In case of a solid, the chemical action generally will be available after the solid is dissolved.

Although the invention is disclosed here referring to machine dishwashing, the skilled person will immediately realise, that the invention has also other fields of application.

Typical dish washing machines, e.g. of the conveyor type, wash the crockery with large amounts of water containing a small amount of detergent. The detergent is directly injected into the water tank below the wash section until a concentration of approximately 0.2 wt % active cleaning agents in the solution is obtained, and water with the detergent is continuously drawn from said tank and poored over the crockery, and is then collected again in said tank. Very heavily soiled crockery is prior to the above described machine treatment subjected to a labor intensive cleaning, so called “stripping”, wherein the crockery is soaked in water with a relatively high concentration of active cleaning agents for several hours.

The prior art contains several proposals to improve the above conventional process by dispersing a minimum amount of highly concentrated, fresh detergent over the crockery and subsequently removing it after a contact time. In EP-A-0465454 the fresh fluid detergent is dispersed as a gentle, mist like spray. In EP-A-406628 the fresh fluid detergent is poured out over the crockery in excess and collected in a separate tank and is drawn therefrom for repeated use. In EP-A-0894469 the fresh fluid detergent is dispersed as a foam. In EP-A-0712599 the fresh detergent is solid and is dispersed as a spray of solid particles which dissolve at the pre-wetted crockery. It is said that with any of these proposals, the chemical action of the detergent is substantially improved at lower detergent consumption for the same or even better cleaning result.

An object of the present invention is a further improvement in the field of dispersing a detergent in a high concentration over the crockery and removing it with a liquid in one or more subsequent steps, providing maximum cleaning effect (a.o. with a view to removal of starch and stains) with minimum detergent consumption and minimum use of labour and machines.

An alternative object of the invention is an application rate wherein the preferably highly concentrated detergent, compared to the water dispersion in a wash zone of a typical conveyor type dish washing machine of 1000 l/hr, is applied at extremely low volume of preferably 100 l/hr at the most, more preferably 25 l/hr at the most, most preferably 10 l/hr at the most, wherein said application volumes relate to the foamless mode of the detergent, e.g. as it is present in the storage container.

Further alternative objects of the invention are: simplifying the equipment or maintenance; preventing failure; to spread as homogeneous as possible a fluid, such as a highly concentrated detergent or another preferably highly concentrated fluid with preferably one or more preferably chemically active substances; efficient generating foam from an e.g. highly concentrated fluid with preferably one or more chemically active substances, such as a detergent; dosing fluid, such as foam, as separate particles; dosing fluid, such as foam, in such a manner as separate particles, that when they settle on an object, such as crockery, they generate an at least essentially continuous, the object at least essentially completely covering layer; dispensing per unit of time an extremely small amount of fluid, particularly with a preferably chemically active substance, such as a liquid detergent; safety.

The invention offers the greatest advantages with machine dish washing processes wherein detergent is directly, e.g. from the storage container, dispersed over the crockery without recirculation and in minimum amounts to cover the surface of the crockery as completely as possible with minimum losses.

The detergent, preferably together with at least part of the soil, is subsequently removed from the crockery, preferably by vigourously flushing comparable to the washing action in a conventional machine dish washer, e.g. by continuously drawing water, possibly with dissolved detergent, in a rate of about 1000 l/hr from a downstream tank, pooring it over the crockery and recollecting it in said tank for renewed use.

The machine dish washer according to the invention is characterised by the modification to carry out the process, such as e.g. the presence of convenient applicator means for foam formation and/or e.g. modification to the control system of the machine. With an exsisting conveyor dish washer, e.g. a Hobarth series FT-E, e.g. model 2-B-3, one or more spraying arms of e.g. a prewash or wash section can be inactivated, to offer room for the applicator means to carry out the process according to the invention.

Preferably the detergent is dispersed over the crockery with a concentration of at least about 0.5 wt %, more preferably at least about 5 wt %, more preferably at least about 10 wt %, more preferably at least about 15 wt %, most preferably 20 wt % of one or more of the active cleaning agents.

If extra chemical action is required, it is prefered to have a contact time before the detergent together with the soil are removed from the crockery. Said contact time preferably lasts at least one, preferably several seconds, more preferably between 5 and 15 seconds. It can be advantageous, e.g. from the viewpoint of optimum chemical action, not to deliberately disperse further detergent or other fluid over the crockery. It can also be advantageous, to provide the detergent on the crockery with as little force as possible, e.g. like a gentle mist.

For an optimum result, the detergent is preferably dispersed such that it completely covers the crockery. Dispersing preferably takes place at low volume and intensity compared to pouring diluted aqueous detergent over the crockery in large jets, as is more typical. The dispersing can be from one single nozzle, but to properly cover the crockery from all sides it is preferred, to apply with a respective nozzle from at least two preferably opposite sides of the crockery. It is expected that with at least two nozzles on each side the dispersing will be most uniform. If e.g. a suspension cloud of detergent is generated, it should however be possible to do with one single nozzle, wherein possible use is made of a convenient, e.g. swirling flow of the cloud, to reach all surfaces of the crockery. Preferably the nozzle aims at the crockery. Preferably the detergent has a temperature substantially lower than the temperature prevailing in the dish washing machine during dispersing, e.g. a temperature at least about similar to room temperature.

The machine dish washing process can have one or more optional pre wash cycles or zones, one or more wash cycles or zones, one or more rinse cycles or zones and one or more dry cycles or zones, wherein according to the invention the dispersing of the detergent takes place prior to the final rinse cycle or zone, preferably prior to the first wash cycle or zone.

The action (e.g. the concentration of the active cleaning agents) of the detergent, dispersed according to the invention and the duration of the contact time (with e.g. a so called conveyor type dish washer provided by the speed of the crockery through the machine and the distance of the applicator section according to the invention to the subsequent rinse or wash section) are preferably mutually adapted such that the soil on the crockery (in particular grease, fats, starch, stains (e.g. from tea) and protein) are sufficient and preferably completely removed, or that in the sense as meant here at least a proper preparation of the crockery is obtained such that the required cleaning result is provided by the subsequent one or more wash cycles or zones. The crockery is e.g. rinsed with water containing the detergent washed from the crockery and provided thereon in the earlier cycle or zone, and possibly seperately added agents.

By way of example the machine for carrying out the process may have a conveyor (e.g. a conveyor belt or chain) to successively pass the crockery, preferably positioned in convenient so called trays, across several sections provided in a common elongated, tunnel like housing and wherein the conveyor extends beyond the front and back of said housing such that the crockery can be fed in and out there, respectively. As such the crockery is successively passed through a pre wash section, an applicator section according to the invention, a wash section, a rinse section, a post rinse section and a dry section. Water is fed to the post rinse section and flows in counter current with respect to the flow of crockery cascade-fashion through the respective tanks of the different sections, and is disposed at the pre wash section. Brightener is dispersed in the post rinse section. Apart from the applicator section, water is pumped from the relevant tank and poored over the crockery and recollected in the tank. The temperature is e.g. 30° C., 50° C. and 70° C. in the pre wash section, wash section and rinse section, respectively. It will be appreciated that according to this embodiment, the crockery is pre wetted before it arrives in the applicator section where the cleaning layer according to the invention is applied. However application of the invention without pre wetting is feasible as well.

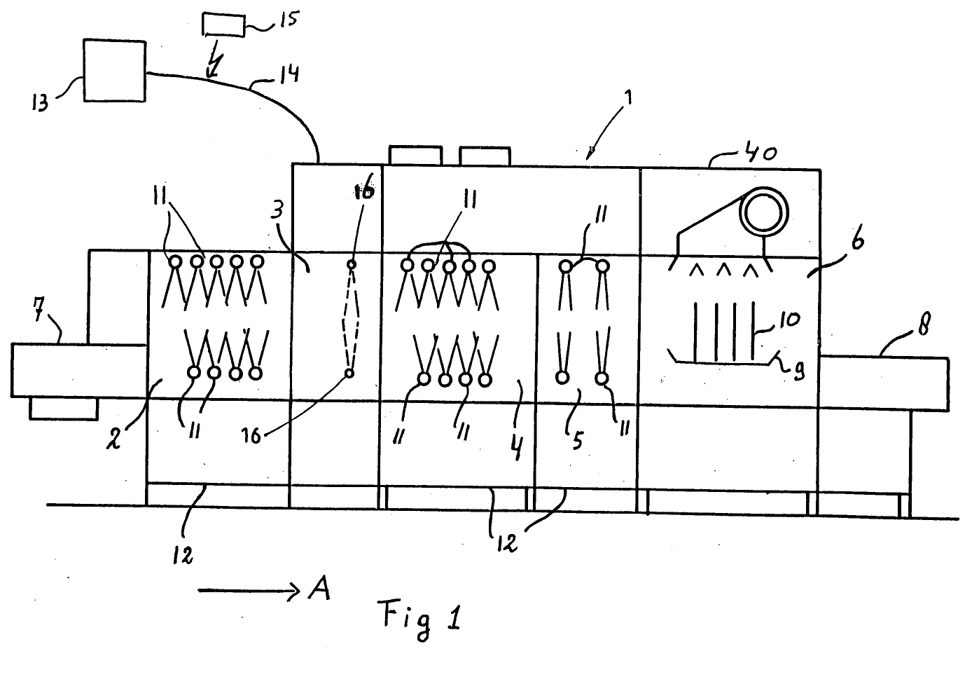

An illustrative dish washing machine to embody this invention can be based on the one that is disclosed in applicant's earlier EP-A-0712599, in particular FIG. 1 and the corresponding specification, for which reason EP-A-0712599 is enclosed in here by reference. For embodying this invention, compared to EP-A-0712599, the section 5 is modified to contain applicator means to carry out the process according to the invention.

While all of the cleaning agents required may be applied over the crockery with dispersing the detergent according to the invention, it may be advantageous that some agents are introduced in a different, perhaps more conventional, manner, e.g. if two or more agents are more or less incompatible if concurrently introduced as a mixture.

The detergent can have each proper format during application, like e.g. liquid, powder, solution, emulsion, gel, paste. Any detergent known to the expert for cleaning crockery can be used, generally if it contains an alkalinic active and/or a sequesteric active component. One or more convenient agents can be added to this substance if required for providing the effect according to the invention. This can e.g. be a convenient colouring agent, or a gelling or foaming or bleaching or dispersing agent or an inhibitor. The dissolving agent can be water, but any convenient non-aqueous dissolving agent as well.

For purposes of further illustration, the invention is further in a non-limiting way described referring to generating a foam layer on the crockery. The foam can be provided by dispersing foam flakes from one or more conveniently located and directed nozzles such that they settle on the crockery, possibly while using an appliance, such as a blower. As an alternative to flakes moving seperately through the air, it is e.g. feasible as well that a foam blanket or foam jet is generated that more or less uninterrupted bridges the distance between the nozzle (nozzles) and the crockery. Alternatively it is feasible that droplets of detergent are dispersed that generate foam either while bridging the distance between the nozzle and the crockery or when settling on the crockery. Such droplets can be e.g. composed of gel or paste. They can also be composed of powder. Combinations of such flakes, blankets, jets and droplets are also feasible. The foam can behave like whirling flakes and more or less smooth on the surface of the crockery, but can also more or less clatter on the crockery like rain.

Foaming can be obtained by adding a foaming system to the detergent. Said foaming system can be mixed with the detergent in advance, or can e.g. be mixed at the moment of application. Preferably a foaming system is selected wherein after washing from the crockery, foaming is suppressed or even prevented, e.g. to substantially accelerate defoaming or foam degradation, e.g. by using different temperature ranges. This option is particularly selected when the foaming action is such that without counter actions there will be a foam formation in a relevant zone of the dish washer by the detergent washed from the crockery, such that the proper functioning of the dish washer is at least interfered or at least substantially made impossible. A foam system is e.g. selected that provides foam at low temperature, but provides at least substantial less foam at high temperature, e.g. above 40° C. An example for this are specific surfactants known to the expert, such as applied as brightener in machine dishwasing processes, wherein the concentration and composition are selected such that a so called cloud point is obtained that is at maximum equal to and is preferably lower than the temperature of. e.g. the water in the wash section. Typically the cloud point and so the temperature above which the foam generating property substantially decreases will fall with rising concentration of said substances. “Cloud point” is the temperature at which the detergent in the concentration of application yields cloudiness in the water, such that there is at least substantially no foam generation any more at and above said temperature. Alternatively a foaming system is selected wherein after being washed from the crockery the foam is contacted by a foam inhibitor, e.g. based on silicon or based on nonionic surfactants. This alternative can also be used in combination with the first mentioned system.

Preferably use is made of a highly concentrated detergent having foaming properties, e.g. having an added foaming agent and applicable in a machine dish washing process, in particular if it has a pH higher than 8 or lower than 6, particularly higher than at least about 12, more preferably higher than at least about 13, most preferably higher than at least about 13.3, e.g. about 13.9. The detergent can contain the here or elsewhere in this disclosure indicated substances in each desired composition. Such detergent then can contain at least about 5 wt %, preferably at least about 10 wt %, more preferably at least about 15 wt % NaOh and/or KOH. The foaming agent can contain surfactants, e.g. be a mixture of nonionic and anionic surfactants, to which e.g. a substance known as such is added to stimulate dissolving of the surfactants at high pH levels. The detergent can contain at least about 1 wt % of the surfactants. A convenient mixture of nonionic and anionic surfactants is such that with rising temperature the foaming action decreases. In that connection it is preferable that the foaming action is at least almost disappeared from a temperature of at least about 60° C., more preferable at least about 50° C., moste preferable at least about 40° C. In this connection it should be appreciated that after it has flown over the crockery the detergent is extremely diluted in the water tank of the wash or rinse zone and that the concentration of the surfactants in the detergent must be high enough to inhibit foaming action in the water tank starting from a treshold temperature.

By way of example a convenient composition of detergent with foaming system for carrying out the process contains NaOH or KOH; a water conditioning agent like NTA, EDTA, phosphates, zeolites or phosphonates; sequestering agents; possibly further agents like a bleaching agent; surfactants; and balance water, wherein the concentration of surfactants is selected such that enough foam is generated while the cloud point is equal to or lower than the temperature of the wash water, and wherein the concentration of NaOH or KOH is selected as high as possible (e.g. between about 20 and about 30 wt %) concerning the other substances, in particular the concentration of surfactants. Based on his general knowledge the expert will be able to select the proper concentrations for the several substances of the detergent. The detergent can be dispersed over the crockery undiluted or diluted, e.g. by admixing water into the line extending from the detergent storage container to the applicator means in the dish washing machine.

The detergent e.g. contains between about 1 wt % and about 5 wt %, preferably about 2 wt % amphoteric, between about 5 wt % and about 10 wt %, preferably about 7 wt % nonionics and between about 5 wt % and about 15 wt %, preferably about 10 wt % hydrotroops. The hydrotroops are an agent to facilitate keeping the nonionics dissolved in an environment with a high concentration of ions, the amphoterics are an agent to facilitate foaming of the nonionics. The nonionics begin to defoam at elevated temperatures. If the concentration of nonionics is higher than the concentration of amphoterics, the defoaming action of the nonionics will counteract the foaming action of the amphoterics, such that the complete foaming action is degraded. An example of a hydrotroop is sodium salt of xylenesulfonate. An example of nonionics is alkylpolyethyleneglycolether(s) with 9 mol EO. An example of amphoteric is alkylamidbetain. The applied amphoteric is preferably based on betain or imidazolin. A convenient alternative for amphoteric is aminoxide.

Another example is the application of a substantially non-foaming detergent which can be based on the compositions as disclosed in here for a foaming detergent, void of the substances providing the foaming action.

A particular aspect of the invention concerns dispensing the fluid in a pulsating manner, e.g. to better ensure that the fluid arrives at the target area. In this manner, the fluid e.g. leaves the dispensing nozzle as a puslating flow, e.g. subsequently ejected single or multiple droplets or particles of fluid, mutually separated in time. This e.g. allows to give the fluid a comparatively large impuls, i.e. the dispersal is more powerful, while minimising fluid consumption.

Preferably the fluid is ejected from the nozzle such that it becomes air borne. When vertically upward ejected from the nozzle, the fluid covers a distance of e.g. at least 2 cm, such as at least 5 cm or even at least 10 cm before arriving at the target. Best results so far were obtained when creating a gentle spray from one or more nozzles, e.g. as a mist or fog or when dispering a foaming fluid or foam flakes, such that the dispersing rate is substantially low.

According to a preferred embodiment, the pulse frequency is below 15 Hz, preferably below 10 Hz, e.g. between 0.1 Hz and 5 Hz, most preferably between 0.5 Hz and 5 Hz, such as about 1 Hz or about 2 Hz. If the fluid is mixed with a carrier, e.g. a gas such as air, it is feasible to have the supply of the fluid and/or the carrier pulsating. If both supplies pulsate, it is preferable that the relevant pulse frequency is substantially equal. Surprisingly, by having both supplies substantially equally pulsating, a more than cumulative effect is obtained. Advantageously, the fluid becomes air borne at substantially the same frequency.

It is preferable that during a single pulsating cycle, the dispensing rate changes at least 10%, preferably at least 20%, most preferably at least about 80%. Best results are obtained if during a single pulsating cycle the dispensing rate rises from zero or almost zero to maximum and than returns to zero, after which the next pulsating cycle commences. It is however feasible that the pulsating cycle is superposed onto a continuous dispensing rate.

To be able to eject the fluid from the nozzle in the desired manner, the fluid and/or carrier are supplied at a pressure of preferably at least 0.5 bar above environmental pressure. Preferably said pressure is between about 1 and about 2 bar, such as about 1.5 bar. Preferably the supply pressures of the fluid and carrier are substantially equal. Obviously, pulsating supply pressures are preferably applied to obtain the pulsating dispersal. Such can be obtained by e.g. a diaphragm pump, known as such, but also with another reciprocating pump, such as a piston pump. Satisfying results are obtained wherein the fluid and carrier pass through a common line or duct and subsequently leave the nozzle.

Another particular aspect of the invention is dispersing a foam, particularly wherein said foam is generated within or near the dispensing nozzle from one or more fluids, such as a liquid or gas. Preferably, said foam is generated from a liquid and a gas, such as environmental air.

The at least one fluid can be processed in a device, such as a static mixing device, with preferably at least two, more preferably at least three preferably widening channels, viewed in the direction of flow, leading to a common outlet and preferably branching from a common supply line. Preferably, said device is integrated in the dispersing nozzle.

In a preferred embodiment, the shape of the assembly of chambers is substantially symmetrical. Preferably, the fluid is allowed to expand in said device, e.g. in each of the channels, advantageously prior to reaching the outlet. Before expanding, the fluid is preferably compressed.

In a specific preferred example, further illustrated by the drawing, the mixing device has a main chamber between two auxiliary chambers each having a volume preferably at least half that of the main chamber. The connection of the main chamber to the common supply line can be at least three times shorter than the connection of an auxiliary chamber to the common supply line. The main chamber can be shaped such that, while flowing towards the outlet, the fluid first expands within a space with opposite walls with smoothly decreasing divergence and then expands within a space with opposite straight diverging walls. Preferably, on its way towards the outlet, the expanded fluid passess a space with converging opposite, preferably straight walls, such that it is compressed. The outlet is preferably designed such that the fluid is ejected as a fan shaped jet or spray, although a cone shaped jet or spray is also contemplated. Within the outlet, the fluid preferably passess diverging opposite walls to be able to expand.

In the following the invention, its advantages and further objects, are illustrated in a non-limiting manner with the aid of an example that is expected to be the best embodiment at this moment.

FIG. 1 shows a sectional side view of a conveyor dishwasher with the dispensing equipment according to the invention;

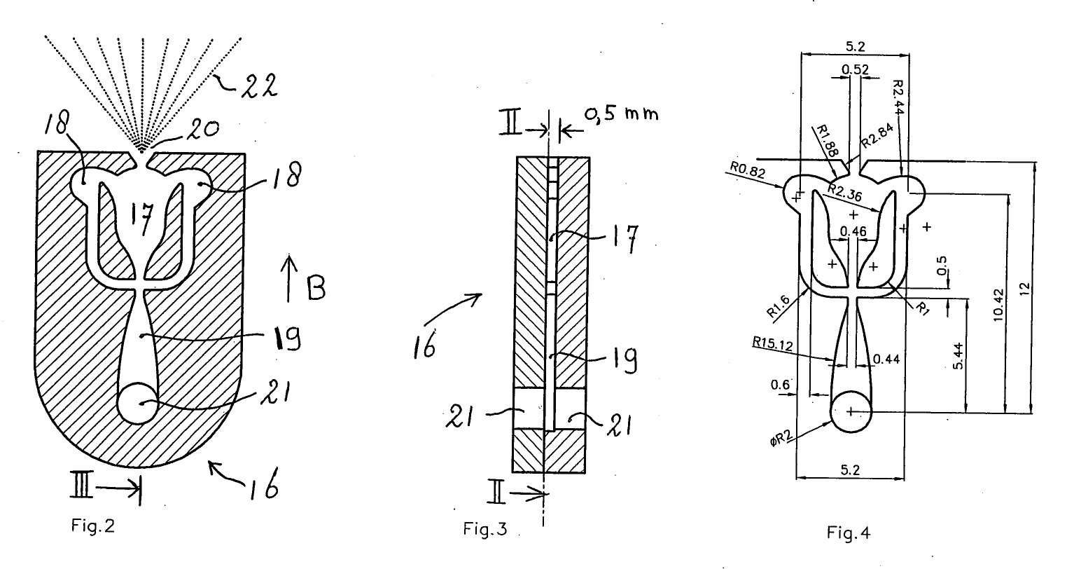

FIG. 2 shows a sectional view along the line II-II in FIG. 3 of the dispensing nozzle of the invention;

FIG. 3 shows a sectional view along the line III-III in FIG. 2; and

FIG. 4 shows a part of FIG. 3.

FIG. 1 shows a conveyor type machine dishwasher 1. It comprises a tunnel shaped housing 40, known as such, containing sequentially one or more optional, pre-wash 2, wash 4, rinse 5 and dry sections 6, all known as such. The tunnel shaped housing also contains a dispensing section 3 according to the invention. A conveyor chain, not shown, extends through the tunnel shaped housing along the above mentioned sections and projects with front and back end beyond the tunnel shaped housing. The e.g. in baskets 9 (only one shown) positioned crockery 10 is placed on the projecting front end of the conveyor belt at the beginning 7 of the machine 1 and moves in the direction of the arrow A while the machine is active, and is removed from the projecting back end of the conveyor belt at the end 8 of the machine 1. As such the crockery 10 is sequentially precessed by the several sections.

In the pre-wash, wash and rinse section the crockery is poured over with water, with dissolved therein possibly a small amount of detergent, at a rate of approximately 1000 l/hr in a way that is common in the field of machine dish washing, for which a plurality of nozzles 11 above, below and next to the conveyor belt direct relatively powerful water jets from all sides onto the passing crockery, to continuously maintain a relatively powerful water flow over the crockery. Said water is collected in the lower part of the machine in for each section an own reservoir 12 with between adjacent reservoirs an overflow. Water is continuously pumped from the reservoirs and through the nozzles 11 spread over the crockery. As is common, tap water, and possibly rinse aid, is dispensed in the reservoir of the last rinse section and superfluous water is removed from the reservoir of the first prewash section. Water flows therefore cascade-like counter to the crockery through the sequential reservoirs 12. The reservoir below the dispensing section 3 can be part of the cascade-flow. Alternatively, it is seperated therefrom to collect superfluous highly concentrated detergent therein for e.g. reuse. Within the machine the following temperatures above room temperature can prevail: 30° C. in pre-wash, 50° C. in wash and rinse, and 70° C. in dry section.

The machine 1 comprises an externally located bin 13 for highly concentrated detergent that is conveyed to the machine 1 through tubing 14, preferably by supplying it to the tubing 14 and sucking it therein. This compound can be liquid, but also be of different particle type, such as granules or powder. The machine 1 also comprises a control unit 15 to control the supply of detergent to the machine 1.

Within the section 3 dispensing nozzle assemblies 16 are arranged above and below the conveyor belt, to direct jets of highly concentrated detergent from below and above onto the wet crockery. In this embodiment there are four such assemblies 16 below and two above the conveyor chain and crockery, mutually spaced in line in the cross machine direction. With each assembly 16 separate fluid particles, such as foam particles or foam flakes, are dosed such that a jet 19 of separate particles is generated, wherein said jet 19 is the enclosure of the particles that each follow a statistic, own path. While the fluid particles move away from the assembly 16, the mutual distance of the fluid particles generally increases while generally the particles each follow an own ballsitic course. The particles settle on different locations onto the crockery and a plurality of said settled particles evenly makes a continuous layer, e.g. a foam layer. With the assembly 16 it is possible, at extremely low dose per unit of time (i.e. few liters of detergent per unit of time) to make a very fine, even distribution of the detergent over the crockery such that an optimised result can be provided at minimised consumption. It is found out that if the assembly 16 is used to dispense a foaming liquid, the assembly 16 can provide a homogeneous, continuous, flattened cone shaped. (i.e. fan shaped) jet. This jet has in the one direction an apex between 60° and 120°, preferably approximately 80° and in the perpendicular direction an apex between 10° and 30°, preferably about 20°, with a consumption of essentially foamless detergent of approximately 5 l/hr to a maximum, preferably approximately 2 l/hr to a maximum. It is appreciated that the consumption of foamed detergent in liters per unit of time will be substantially higher. After a contact time of preferably 5 to 100 s, more preferably 8 to 25 s, the foam layer is removed from the crockery, preferably rinsed in one or more of the succeeding sections or phases.

The assembly 16 (see FIG. 2-4) comprises three shallow chambers 17, 18, connected to a common inlet 19 and a common outlet 20. The inlet 19 has a channel, narrowing in the direction of flow (arrow B) and connecting to two opposite supply lines 21, each for a fluid, such as a gas or liquid. Thus, coming from the supply line, the fluid makes a turn of approximately 90° to flow into inlet 19 which is in line with the mixing chambers 17, 18.

Chamber 17 is the main chamber, chambers 18 are the auxiliary chambers. The depth of these chambers, the outlet 20 and the inlet 19 is substantially constant.

During operation, the fluids from supply lines 21 combine in inlet 19 and then this combined flow is compressed and branches off towards chambers 17, 18 where it expands and develops a swirling motion. Near the outlet 20 the flow recombines and is compressed and then expands within the outlet 20 and is subsequently ejected, developing the desired jet or spray. In case this flow has foaming capacity, said foam develops within chambers 17, 18.

FIG. 4 indicates the typical dimensions of the assembly 16 in mm. It is appreciated that in practise any of these dimensions can measure 10% higher or lower, independent of any other dimension.

From this presently preferred embodiment it should be clear that the foam is generated within the machine dishwasher, inside the section 3 and substantially immediately prior to ejecting the fluid.

The scope of the invention also covers embodiments based on one or more individual features of one of the disclosed embodiments, possibly combined with one or more individual features of one or more others of the disclosed embodiments and/or one or more features from the prior art. Said scope also covers embodiments having one or more features replaced by an equivalent.

In stead of a piston pump a peristaltic pump can be used, or pulsating can be obtained by opening/closing a valve or equivalent means in a pressurised line. Foam generation also enhances pulsating dispensing.

The prior art already discloses use of a diafragma pump to disperse a detergent into a machine dish washer, however only dispering in a continuously manner and without dispersing in a pulsating manner.

1. Machine dish washing process wherein a preferably highly concentrated detergent is supplied from a storage supply and is dispersed as e.g. foam flakes or a foam jet from at least one nozzle over crockery within the dish washing machine and is allowed to settle on said crockery such that said crockery is washed with said detergent and said detergent is removed from said crockery after a contact time, wherein said detergent is dispersed in a pulsating manner, e.g. said detergent leaves the nozzle as a pulsating flow.

2. Process according to claim 1, wherein the pulse frequency is below 15 Hz, preferably below 10 Hz, e.g. between 0.1 Hz and 5 Hz, most preferably between 0.5 Hz and 5 Hz, such as about 1 Hz or about 2 Hz.

3. Process according to claim 1, wherein during a single pulsating cycle, the dispensing rate changes at least 10%, preferably at least 20%, most preferably at least about 80%, e.g. from substantially zero to maximum and back to substantially zero.

4. Process according to claim 1, wherein the detergent is mixed with a carrier fluid, e.g. a gas such as air, prior to or during leaving the nozzle, which carrier fluid is supplied as a pulsating flow and/or wherein said detergent is supplied to said nozzle in a pulsating manner.

5. Process according to claim 4, wherein said carrier fluid and said detergent are supplied at substantially the same pulse frequency and/or pass through a common line or duct and subsequently leave the nozzle.

6. Process according to claim 1, wherein said detergent and/or carrier fluid are supplied at a pressure of preferably at least 0.5 bar above environmental pressure, which pressure preferably pulsates, e.g. provided by a diaphragm pump.

7. Process according to claim 1, wherein said detergent is passed through a static mixing device integrated in the dispersing nozzle, with preferably at least two, more preferably at least three preferably widening channels (17, 18), viewed in the direction of flow, leading to a common outlet (20) and preferably branching from a common supply line (19).

8. Process according to claim 7, wherein the shape of the assembly of chambers is substantially symmetrical and/or said detergent is allowed to expand in said static mixing device, e.g. in each of the channels (17, 18) and before expanding, the said detergent is preferably compressed.

9. Process according to claim 7, wherein said static mixing device has a main chamber (17) between two auxiliary chambers (18) each having a volume preferably at least half that of the main chamber and/or the connection of the main chamber to the common supply line is at least three times shorter than the connection of an auxiliary chamber to the common supply line

10. Process according to claim 9, wherein said main chamber (17) is shaped such that, while flowing towards the outlet, the detergent first expands within a space with opposite walls with smoothly decreasing divergence and then expands within a space with opposite straight diverging walls and, on its way towards the outlet, the expanded detergent passess a space with converging opposite, preferably straight walls, such that it is compressed and is ejected from the outlet (20) as a fan shaped jet or spray, while passing diverging opposite walls of said oulet to be able to expand.
